(19) United States
(12) Patent Application Publication
(10) Pub. No.: US 2024/0382938 A1
(43) Pub. Date: Nov. 21, 2024

(54) SYNTHESIS OF CHA ZEOLITIC MATERIALS, CHA ZEOLITIC MATERIALS OBTAINABLE THEREFROM AND SCR CATALYSTS COMPRISING THE SAME

(71) Applicant: BASF CORPORATION, Florham Park, NJ (US)

(72) Inventors: Lihua SHI, Liaoning (CN); Xiaoduo QI, Shanghai (CN); Vivek VATTIPALLI, Iselin, NJ (US); Yu DAI, Shanghai (CN); Mingming WEI, Shanghai (CN); Haitao LIU, Liaoning (CN); Jin LI, Liaoning (CN)

(21) Appl. No.: 18/690,126

(22) PCT Filed: Sep. 8, 2022
(86) PCT No.: PCT/CN2022/117802

§ 371 Date: Mar. 7, 2024

(30) Foreign Application Priority Data
Sep. 9, 2021 (WO) PCT/CN2021/117349

(51) Int. Cl. B01J 29/76; B01D 53/94; B01J 37/00; B01J 37/02; B01J 37/03; B01J 37/04; C01B 39/48; F01N 3/20; F01N 3/28

(52) U.S. Cl. CPC B01J 29/763; B01D 53/9418; B01J 37/0018; B01J 37/0215; B01J 37/031; B01J 37/04; C01B 39/48; F01N 3/2066; F01N 3/2803; B01D 2255/20738; B01D 2255/20761; B01D 2255/50; B01D 2257/404; F01N 2370/04; F01N 2510/068

(57) ABSTRACT

A process for preparing a zeolite having a CHA-type framework structure, the framework structure comprising X₂O₃ and YO₂, wherein X is a trivalent element and Y is a tetravalent element, which includes (1) preparing a synthesis mixture comprising (A) a source for X₂O₃, (B) a source for YO₂, and (C) a source for piperidinium cations represented by formula (I) wherein R₁ₐ is selected from C₁-C₈ alkyl and C₃-C₁₀ cycloalkyl, R_{1b} is selected from C₂-C₈ alkyl and C₃-C₁₀ cycloalkyl, and R₂, R₃, R₄, R₅ and R₆ independently from each other, are H, hydroxyl or C₁-C₈ alkyl; and (2) subjecting the synthesis mixture to crystallization conditions to form a CHA zeolite.

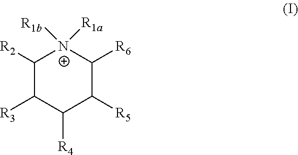

### FIELD OF THE INVENTION

The present invention relates to a process for synthesis of zeolitic materials having CHA framework structure, the zeolitic materials obtainable therefrom, and SCR catalysts comprising the same.

### BACKGROUND

Catalytic articles are essential for modern internal combustion engines to treat exhausts therefrom before emission to air. The exhausts from internal combustion engines typically comprise particulate matter (PM), nitrogen oxides (NOx) such as NO and/or NO₂, unburned hydrocarbons (HC), and carbon monoxide (CO). Control of emissions of NOx is always one of the most important topics in automotive field, due to the environmentally negative impact of NOx on ecosystem, animal and plant life.

One of effective techniques for removal of NOx from internal combustion engine exhausts, is selective catalytic reduction (SCR) of NOx with ammonia or a secondary ammonia source. Recently, small pore zeolites were proposed for the selective catalytic reduction of NOx, among which CHA-type zeolite have been studied extensively and found as one of the most promising SCR catalysts, particularly when the zeolite is exchanged with a metal promoter such as Cu or Fe.

Chabazite is a type of naturally occurring zeolites, and also has synthetic CHA forms. A well-known synthetic CHA-type zeolite is the crystalline CHA material designated as SSZ-13, as reported in U.S. Pat. No. 4,544,538. SSZ-13 was prepared using a structure directing agent comprising N-alkyl-3-quinuclidinol cation, N,N,N-trialkyl-1-adamantammonium cation, N,N,N-trialkyl-2-exoaminonorbornane cation or mixtures thereof under crystallization conditions. Synthesis of CHA-type zeolite using other structure directing agents has also been developed, as reported for example in following non-patent and patent documents.

Itakura Masaya et. al. in Chemistry Letters, 2008, Vol. 37, No. 9, pages 908 to 909, describes a process for synthesis of CHA Zeolite with benzyltrimethylammonium hydroxide as the structure directing agent.

US 2010/254895 A1 discloses a process for preparing CHA-type zeolite using cationic 1,4-diazabicyclo[2.2.2] octane-based structure directing agent in conjunction with at least one cationic cyclic nitrogen-containing structure directing agent.

WO 2020/039074A1 discloses a process for preparing CHA-type zeolite using a structure directing agent comprising the cation having the formula [NR¹R²R³R⁴], in which R¹, R², R³ and R₄ are independently C₁-C₄-alkyl groups optionally substituted by one or more hydroxy groups.

Biaohua Chen et al. in Environmental Science & Technology, 2014, 48, pages 13909 to 13916, describes a process for synthesis of SSZ-13 with choline chloride as the structure directing agent.

WO 2013/035054 A1 relates to a process for the preparation of a zeolitic material having a CHA-type framework structure, wherein the process employs N,N-dimethylammonium organotemplates including N,N-dimethylpiperidinium.

There remains a need of more processes for preparing zeolite materials having CHA frame structure, particularly processes which could provide CHA-type zeolite materials having improved catalytic performance for selective catalytic reduction of NOx.

### SUMMARY OF THE INVENTION

It is an object of the present invention to provide a novel process for preparing a zeolite material having CHA framework structure. Another object of the present invention is to provide an SCR catalyst based on a zeolite having CHA framework structure, which has improved catalytic performance for selective catalytic reduction of NOx.

The objects were achieved by using a piperidinium-based organic structure directing agent in the zeolite synthesis. It has been surprisingly found that the zeolite having CHA framework structure as prepared with the piperidinium-based organic structure directing agent has desirable activity, particularly combined with excellent stability against aging at a high temperature, for example 800° C. or higher.

Accordingly, in the first aspect, the present invention relates to a process for preparing a zeolite material having a CHA-type framework structure, the framework structure comprising X₂O₃ and YO₂, wherein X is a trivalent element and Y is a tetravalent element, which includes
(1) preparing a synthesis mixture comprising
   (A) a source for X₂O₃,
   (B) a source for YO_{2,} and
   (C) a source for piperidinium cations represented by formula (I) as an organic structure directing agent (OSDA),

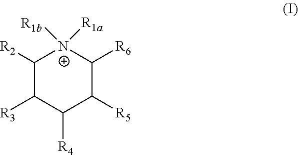

wherein
R₁ₐ is selected from C₁-C₈ alkyl and C₃-C₁₀ cycloalkyl,
R_{1b} is selected from C₂-C₈ alkyl and C₃-C₁₀ cycloalkyl, and
R₂, R₃, R₄, R₅ and R₆ independently from each other, are H, hydroxyl or C₁-C₈ alkyl; and
(2) subjecting the synthesis mixture to crystallization conditions to form a CHA zeolite.

In the second aspect, the present invention relates to a zeolite having a CHA-type framework structure obtained and/or obtainable by the process as described herein.

In the third aspect, the present invention relates to a zeolite having a CHA-type framework structure obtained and/or obtainable by the process as described herein, wherein the zeolite comprises a promoter metal M.

In the fourth aspect, the present invention relates to use of the zeolite having a CHA-type framework structure according to the second or third aspects in catalysts for selective catalytic reduction (SCR) of NOx.

In the fifth aspect, the present invention relates to a catalytic article in form of extrudates comprising an SCR catalyst composition or in form of a monolith comprising a washcoat containing an SCR catalyst composition on a substrate, wherein the SCR catalyst composition comprises a zeolite having a CHA-type framework structure comprising a promoter metal as described herein.

In the sixth aspect, the present invention relates to an exhaust gas treatment system comprising an internal combustion engine and an exhaust gas conduit in fluid communication with the internal combustion engine, wherein the catalytic article as described herein is present in the exhaust gas conduit.

### BRIEF DESCRIPTION OF THE DRAWINGS

FIG. 1 shows SEM images of the zeolites from Examples 1 to 6 respectively.

FIG. 2 shows XRD patterns of the zeolites from Examples 1 to 7 respectively.

### DETAILED DESCRIPTION OF THE INVENTION

The present invention will be described in detail hereinafter. It is to be understood that the present invention may be embodied in many different ways and shall not be construed as limited to the embodiments set forth herein.

Herein, the singular forms “a”, “an” and “the” include plural referents unless the context clearly dictates otherwise. The terms “comprise”, “comprising”, etc. are used interchangeably with “contain”, “containing”, etc. and are to be interpreted in a non-limiting, open manner. That is, e.g., further components or elements may be present. The expressions “consists of” or “consists essentially of” or cognates may be embraced within “comprises” or cognates.

The terms “zeolite having a CHA-type framework structure”, “CHA-type zeolite”, “CHA zeolite” and the like as used herein are intended to refer to a molecular sieve material which shows an XRD pattern of a CHA-type framework structure, and will be used interchangeably with each other hereinbelow. Those terms are also intended to include any forms of the zeolite, for example as-synthesized form, calcined form, NH₄-exchanged form, H-form and metal-substituted form.

The term “as-synthesized” as used herein is intended to refer to a zeolite in its form after crystallization and drying, prior to removal of the organic structure directing agent.

The term “calcined form” as used herein is intended to refer to a zeolite in its form upon calcination.

In the first aspect, the present invention provides a process for preparing a zeolite having a CHA-type framework structure, the framework structure comprising X₂O₃ and YO₂, wherein X is a trivalent element and Y is a tetravalent element, which includes
(1) preparing a synthesis mixture comprising
   (A) a source for X₂O₃,
   (B) a source for YO₂, and
   (C) a source for piperidinium cations represented by formula (I) as an organic structure directing agent (OSDA),

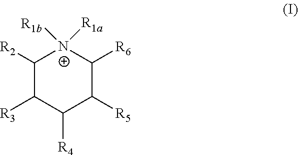

wherein
R₁ₐ is selected from C₁-C₈ alkyl and C₃-C₁₀ cycloalkyl,
R_{1b} is selected from C₂-C₈ alkyl and C₃-C₁₀ cycloalkyl, and
R₂, R₃, R₄, R₅ and R₆ independently from each other, are H, hydroxyl or C₁-C₈ alkyl; and
(2) subjecting the synthesis mixture to crystallization conditions to form a CHA zeolite.

The synthesis mixture provided in step (1) comprises a source for X₂O₃ where X is a trivalent framework element and a source for YO₂ where Y is a tetravalent framework element. X may be any trivalent element. Preferably, X is selected from the group consisting of Al, B, In, Ga and any combinations thereof, with Al being more preferable. Also, Y may be any tetravalent element. Preferably, Y is selected from the group consisting of Si, Sn, Ti, Zr, Ge and any combinations thereof, with Si being more preferable. Particularly, X is Al and Y is Si.

Suitable source for X₂O₃ may be any known materials useful for providing trivalent framework element during zeolite synthesis. In some embodiments wherein X is Al, suitable examples of the source for Al₂O₃ may include, but are not limited to alumina, aluminium hydroxide, aluminates, aluminum alkoxides, aluminum salts, FAU zeolites, LTA zeolites, LTL zeolites, BEA zeolites, MFI zeolites and any combinations thereof, more preferably alumina, aluminum alkoxide, aluminum salts, FAU zeolites and any combinations thereof. Particularly, the source for Al₂O₃ may be selected from alumina, AlO(OH), Al(OH)₃, aluminum tri(C₁-C₅)alkoxide, aluminum halides, aluminum sulfate, aluminum phosphate, aluminum fluorosilicate, FAU zeolites and any combinations thereof. For example, the FAU zeolite may be selected from the group consisting of faujasite, [Al—Ge—O]-FAU, [Al—Ge—O]-FAU, [Ga—Al—Si—O]-FAU, [Ga—Ge—O]-FAU, [Ga—Si—O]-FAU, CSZ-1, Na—X, US—Y, ECR-30, LZ-210, Li-LSX, SAPO-37, Na—Y, ZSM-20, ZSM-3, Zeolite X and Zeolite Y, more preferably from the group consisting of faujasite, Na—X, zeolite X, zeolite Y, US—Y and LZ-210. Zeolite Y may be particularly mentioned as the source for X₂O₃.

Suitable source for YO₂ may be any known materials useful for providing tetravalent framework element during zeolite synthesis. In some embodiments wherein Y is Si, suitable sources for YO₂ may include, but are not limited to fumed silica, precipitated silica, silica hydrosols, silica gels, colloidal silica, silicic acid, silicon alkoxides, alkali metal silicates, sodium metasilicate hydrate, sesquisilicate, disilicate, silicic acid esters, FAU zeolites, LTA zeolites, LTL zeolites, BEA zeolites, MFI zeolites and any combinations thereof. Particularly, the source for YO₂ may be selected from fumed silica, sodium silicate, potassium silicate, FAU zeolites and any combinations thereof, more preferably fumed silica, FAU zeolites and any combinations thereof. For example, the FAU zeolite may be selected from the group consisting of faujasite, [Al—Ge—O]-FAU, [Al—Ge—O]-FAU, [Ga—Al—Si—O]-FAU, [Ga—Ge—O]-FAU, [Ga—Si—O]-FAU, CSZ-1, Na—X, US—Y, ECR-30, LZ-210, Li-LSX, SAPO-37, Na—Y, ZSM-20, ZSM-3, Zeolite X and Zeolite Y, more preferably from the group consisting of faujasite, Na—X, zeolite X, zeolite Y, US—Y, and LZ-210. Particularly, one or more materials selected from the group consisting of fumed silica, precipitated silica, silica hydrosols, silica gels, colloidal silica and zeolite Y may be mentioned as the source for YO₂.

It will be understood that the sources for X₂O₃ and YO₂ may be provided separately (i.e., separate sources) and/or conjointly (i.e., combined sources). In the latter case, the sources may be provided by for example a zeolite containing framework elements X and Y. It can be contemplated that the synthesis mixture provided in step (1) may comprise a combined source for X₂O₃ and YO₂ and one or both of separate sources for X₂O₃ and YO₂.

In some particular embodiments, the synthesis mixture provided in step (1) comprises a source for Al₂O₃ and a source for SiO₂. Accordingly, an aluminosilicate zeolite having CHA framework structure will be obtained from the process according to the present invention.

The term “aluminosilicate” as used within the context of zeolite is intended to mean the framework constructed primarily of alumina and silica, which may or may not comprise a framework element other than oxygen, aluminum, and silicon.

In certain illustrative embodiments, the synthesis mixture provided in step (1) comprises an FAU zeolite as the combined sources for Al₂O₃ and SiO₂ and an additional source for SiO₂. Particularly the FAU zeolite is zeolite Y, preferably zeolite Y having a molar ratio of SiO₂ to Al₂O₃ of no more than 40, no more than 30, no more than 20, or even no more than 10. The additional source for SiO₂ is selected from the group consisting of fumed silica, precipitated silica, silica hydrosols, silica gels and colloidal silica, including mixtures of two or more thereof.

The synthesis mixture provided in step (1) has a YO₂:X₂O₃ molar ratio of the source for YO₂ calculated as YO₂ to the source for X₂O₃ calculated as X₂O₃ in the range of from 5 to 100, for example 15 to 80, 35 to 60, or 40 to 60.

In some embodiments, the organic structure directing agent is a compound containing the piperidinium cation represented by the following formula (I)

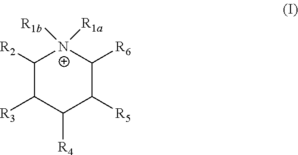

wherein
R₁ₐ is selected from C₁-C₈ alkyl and C₃-C₁₀ cycloalkyl,
R_{1b} is selected from C₃-C₈ alkyl and C₃-C₁₀ cycloalkyl, and
R₂, R₃, R₄, R₅ and R₆ independently from each other, are H, hydroxyl or C₁-C₈ alky.

In some further embodiments, the organic structure directing agent is a compound containing the piperidinium cation represented by the following formula (Ia)

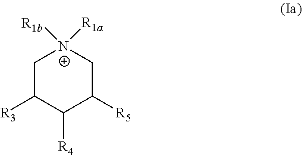

wherein
R₁ₐ is selected from C₁-C₅ alkyl and C₅-C₁₀ cycloalkyl,
R_{1b} is selected from C₃-C₅ alkyl and C₅-C₁₀ cycloalkyl, and
R₃, R₄ and R₅ independently from each other, are H, hydroxyl or C₁-C₅ alkyl.

Particularly, the organic structure directing agent is a compound containing the piperidinium cation represented by formula (Ia) wherein R₁ₐ is C₁-C₅ alkyl, R_{1b} is C₃-C₅ alkyl, and R₃, R₄ and R₅ independently from each other, are H, hydroxyl or C₁-C₅ alkyl.

More particularly, the organic structure directing agent is a compound containing the piperidinium cation represented by formula (Ia) wherein R₁ₐ is C₁-C₃ alkyl, R_{1b} is C₃-C₅ alkyl, R₃ and R₅ independently from each other are H or C₁-C₅ alkyl, and R₄ is H.

In certain illustrative embodiments, the organic structure directing agent is a compound containing the piperidinium cation represented by formula (Ia) wherein R₁ₐ is C₁-C₃ alkyl, R_{1b} is C₃-C₅ alkyl, R₃, R₄ and R₅ are H.

For example, the organic structure directing agent is selected from compounds containing 1-methyl-1-ethylpiperidinium, 1-methyl-1-n-propylpiperidinium, 1-methyl-1-n-butylpiperidinium, 1,1-diethylpiperidinium, 1-ethyl-1-n-propylpiperidinium or 1-ethyl-1-n-butylpiperidinium, or may be any combinations of the compounds, among which compounds containing 1-methyl-1-n-propylpiperidinium, 1-methyl-1-n-butylpiperidinium or 1-ethyl-1-n-propylpiperidinium, and any combinations thereof may be particularly mentioned.

In some particular embodiments, the synthesis mixture provided in step (1) comprises no organic structure directing agent cations other than the piperidinium cations.

Suitably, the organic structure directing agent may be in form of salts of the piperidinium cation. There is no particular restriction to the counterion contained in the organic structure directing agent, which may be selected from the group consisting of halide such as fluoride, chloride and bromide, hydroxide, sulfate, nitrate and carboxylate such as acetate, preferably selected from the group consisting of chloride, bromide, hydroxide and sulfate.

Preferably, the organic structure directing agent are hydroxides, chlorides or bromides, and particularly hydroxides of the piperidinium cations of formula (I) and (Ia) as described herein above.

The organic structure directing agents may be present in the synthesis mixture provided in step (1) in a piperidinium:YO₂ molar ratio relative to source(s) for YO₂, calculated as YO₂, in the range of from 0.01 to 1.0, for example 0.03 to 0.5, 0.03 to 0.2, or 0.05 to 0.15.

The synthesis mixture provided in step (1) may further comprise a source for alkali metal and/or alkaline earth metal cations (AM), preferably alkali metal cations. The alkali metal is preferably selected from the group consisting of Li, Na, K, Cs and any combinations thereof, more preferably Na and/or K, and most preferably Na. The alkaline earth metal is preferably selected from the group consisting of Mg, Ca, Sr and Ba and any combinations thereof. Suitable sources for alkali metal and/or alkaline earth metal cations (AM) are typically halide such as fluoride, chloride and bromide, hydroxide, sulfate, nitrate and carboxylate such as acetate of alkali metal and/or alkaline earth metal, or any combinations thereof. Preferably, the sources for the alkali metal and/or alkaline earth metal cations (AM) include chloride, bromide, hydroxide or sulfate of the alkali metal and/or alkaline earth metal, or any combinations thereof. More preferably, hydroxide of alkali metal is used in the synthesis mixture.

The alkali metal and/or alkaline earth metal cations (AM) may be present in the synthesis mixture in a molar ratio relative to the source(s) for YO₂, calculate as AM to YO₂, in the range of from 0.01 to 1.0, for example 0.1 to 1.0, 0.3 to 0.8, or 0.5 to 0.7.

The synthesis mixture provided in step (1) may also comprise a source for the anion OH⁻. Useful source for OH⁻ may be for example a metal hydroxide such as alkali metal hydroxide or ammonium hydroxide. Preferably, the anion OH⁻ may be originated from one or more of the source for alkali metal and/or alkaline earth metal cations (AM) and the organic structure directing agent.

The OH⁻ anions may be present in the synthesis mixture in a molar ratio relative to the source(s) for YO₂, calculated as OH⁻ to YO₂, in the range of from 0.1 to 2.0, for example 0.2 to 1.0, or 0.5 to 1.0.

The synthesis mixture provided in step (1) may also comprise at least one solvent, preferably water, more preferably deionized water. The solvent may be comprised in one or more of starting materials of the synthesis mixture, such as the sources for X₂O₃, YO₂ and the organic structure directing agent and thus be carried into the synthesis mixture, and/or may be incorporated into the synthesis mixture separately.

In some embodiments, the synthesis mixture has a molar ratio of water to the source(s) for YO₂, calculated as H₂O to YO₂, in the range of from 3 to 100, for example 10 to 80, 20 to 70, or 30 to 60.

In some exemplary embodiments, the synthesis mixture provided in step (1) have a molar composition as shown in the Table 1 below.

TABLE 1

| Ingredient Ratios¹⁾ | Broad | narrow | narrower | narrowest |
|---|---|---|---|---|
| YO₂/X₂O₃ | 5 to 100 | 15 to 80 | 15 to 60 | 15 to 30 |
| Q/YO₂ | 0.01 to 1.0 | 0.03 to 0.5 | 0.03 to 0.2 | 0.05 to 0.15 |
| AM/YO₂ | 0.01 to 1.0 | 0.1 to 1.0 | 0.3 to 0.8 | 0.5 to 0.7 |
| OH⁻/YO₂ | 0.1 to 2.0 | 0.2 to 1.0 | 0.3 to 1.0 | 0.5 to 1.0 |
| H₂O/YO₂ | 3 to 100 | 10 to 80 | 20 to 70 | 20 to 60 |

¹⁾the amounts of the sources for X₂O₃ and YO₂ are calculated as respective oxides

In some embodiments, the synthesis mixture provided in step (1) may further comprise an amount of seed crystals of CHA zeolite. The seed crystals of CHA zeolite may be obtained from the process as described herein without using seed crystals, or any other known processes.

The synthesis mixture may be subjected to crystallization conditions to form a CHA zeolite in step (2) with no particular restriction. The crystallization may be carried out at an elevated temperature in the range of from 80 to 250° C., more preferably from 100 to 200° C., for a period sufficient for crystallization, for example 0.5 to 12 days, or 1 to 6 days. Typically, the crystallization is carried out under autogenous pressure, for example in a pressure tight vessel such as an autoclave. Further, the crystallization may be carried out with or without agitation.

The CHA zeolite as formed by crystallization may be subjected to a work-up procedure including isolating for example by filtration, optionally washing, and drying to obtain the as-synthesized CHA zeolite. Accordingly, step (2) in the process according to the present invention optionally further comprises the work-up procedure.

The as-synthesized CHA zeolite typically comprises the piperidinium cations as described hereinabove within its structure pores and/or channels.

In some embodiments, the as-synthesized CHA zeolite from step (2) may be subjected to a calcination procedure. Accordingly, the process according to the present invention further comprises step (3) of calcination of the as-synthesized CHA zeolite.

In some embodiments, the as-synthesized or the as-calcined CHA zeolite may be subjected to an ion-exchange procedure such that one or more of ionic non-framework elements contained in the zeolite are exchanged to H⁺ and/or NH₄⁺. Accordingly, the process according to the present invention further comprises
(4) exchanging one or more of ionic non-framework elements contained in the zeolite obtained in step (2) or (3) to H⁺ and/or NH₄⁺, preferably NH₄⁺.

Generally, the zeolite having been exchanged to H⁺ and/or NH₄⁺ in step (4) may be subjected to a work-up procedure including isolating for example by filtration, optionally washing, and drying, and/or subjected to a calcination procedure. Accordingly, step (4) in the process according to the present invention optionally further comprises the work-up procedure and/or calcination procedure.

The calcination in step (3) and/or step (4) may be carried out at a temperature in the range of from 300 to 900° C., for example 350 to 700° C., or 400 to 650° C. Particularly, the calcination may be performed in a gas atmosphere having a temperature in the above-described ranges, which may be air, oxygen, nitrogen, or a mixture of two or more thereof. Preferably, the calcination is performed for a period in the range of from 0.5 to 10 hours, for example 3 to 7 hours, or 4 to 6hours.

Zeolites having CHA framework structure could be successfully obtained from the processes as described in the first aspect, as determined by X-ray powder diffraction (XRD) analysis.

Accordingly, in the second aspect, the present invention also provides a zeolite having a CHA-type framework structure obtainable and/or obtained from the processes as described in the first aspect.

The zeolite having a CHA-type framework structure has a YO₂:X₂O₃ molar ratio (SAR) of YO₂ (e.g. silica) to X₂O₃ (e.g. alumina) of 2 or more, wherein the molar ratio is preferably comprised in the range of from 4 to 200, more preferably of from 6 to 100, more preferably of from 8 to 50, more preferably of from 10 to 35, more preferably of from 11 to 25, more preferably of from 11.5 to 20, more preferably of from 12 to 16, more preferably of from 12.5 to 15, and more preferably of from 13 to 14. According to the present invention, the YO₂:X₂O₃ molar ratio preferably refers to the zeolite having a CHA-type framework structure in its calcined form, more preferably in its calcined H-form.

The zeolite having CHA framework structure according to the present invention typically has an average crystal size of up to 2 μm, or up to 1.5 μm, for example in the range of from 200 nm to 1.5 μm. The average crystal size may be determined via scanning electron microscopy (SEM). Particularly, the average crystal size was determined via SEM by measuring the crystal sizes for at least 30 different crystals selected at random from multiple images covering different areas of the sample.

In some embodiments, the zeolite having a CHA-type framework structure according to the present invention may have a mesopore surface area (MSA) of no more than 60 m²/g, preferably no more than 50 m²/g, more preferably no more than 45 m²/g, for example 1 to 50 m²/g, or 3 to 40 m²/g. Alternatively or additionally, the zeolite having a CHA-type framework structure has a zeolitic surface area (ZSA) of at least 400 m²/g, or at least 450 m²/g, for example in the range of 450 to 650 m²/g or 450 to 600 m²/g. The MSA and ZSA may be determined via N₂-adsorption porosimetry.

The zeolite having a CHA-type framework structure according to the present invention is preferably at least 90% phase pure, i.e., at least 90% of the zeolite framework is of CHA type, as determined by X-ray powder diffraction (XRD) analysis. More preferably, the zeolite having a CHA-type framework structure is at least 95% phase pure, or even more preferably at least 98% or at least about 99%. Correspondingly, the zeolite having a CHA-type framework structure may contain some other framework as intergrowth in minor amounts, for example less than 10%, preferably less than 5%, even more preferably less than 2% or less than 1%.

It has been surprisingly found that the zeolite having a CHA-type framework structure as obtained from the processes as described in the first aspect exhibits significantly higher stability against aging at a temperature of 800° C. or higher in the application of selective catalytic reduction (SCR) of NOx, compared with the catalysts comprising a zeolite having the same framework type but prepared otherwise.

Accordingly, in the third aspect, the present invention further provides a zeolite having a CHA-type framework structure obtained and/or obtainable by the process according to the present invention, wherein the zeolite comprises a promoter metal M.

The term “promoter metal” as used herein preferably refers to a non-framework metal capable of improving the catalytic activity of a zeolite. The “non-framework metal” is intended to mean that the metal does not participate in constituting the zeolite framework structure. The promoter metal may reside within the zeolite and/or on at least a portion of the zeolite surface, preferably in form of ionic species.

Particularly, the promoter metal is present within and/or on the zeolite having a CHA-type framework structure.

The zeolites having a CHA-type framework structure are those as obtained and/or obtainable by the processes as described in the first aspect and/or as described in the second aspect. Any general and particular description with respect to the processes in the first aspect or the zeolites having a CHA-type framework structure as in the second aspect are incorporated here by reference.

The promoter metal may be any metals known useful for improving catalytic performance of zeolites in the application of selective catalytic reduction (SCR) of NOx. Generally, the promoter metal may be selected from transition metals, for example precious metals such as Au and Ag and platinum group metals, base metals such as Cr, Zr, Nb, Mo, Fe, Mn, W, V, Ti, Co, Ni, Cu and Zn, alkali earth metals such as Ca and Mg, and Sb, Sn and Bi, and any combinations thereof.

In a preferable embodiment, the zeolite having a CHA-type framework structure comprises at least Cu and/or Fe as the promoter metal. In some particular embodiments, the zeolite comprises Cu as the promoter metal. Particularly, the promoter metal in the zeolite consists of Cu.

The promoter metal may be present in the zeolite having a CHA-type framework structure at an amount of 0.1 to 10% by weight, preferably 0.5 to 10% by weight, on an oxide basis, based on the total weight of the promoter metal and the zeolite having a CHA-type framework structure. In some particular embodiments wherein copper, iron or the combination thereof is used as the promoter metal, the promoter metal is preferably present in the zeolite having a CHA-type framework structure at an amount of 1 to 8% by weight, more preferably 2 to 7% by weight, on an oxide basis, based on the total weight of the promoter metal and the zeolite having a CHA-type framework structure.

Alternatively, the promoter metal may be present in the zeolite having a CHA-type framework structure at an amount of 0.01 to 2 moles, preferably of 0.03 to 1.8 moles, more preferably of 0.05 to 1.5 moles, more preferably of 0.08 to 1.2 moles, more preferably of 0.1 to 1.0 moles, more preferably of 0.13 to 0.8 moles, more preferably of 0.15 to 0.5 moles, more preferably of 0.18 to 0.4 moles, more preferably of 0.2 to 0.38 moles, more preferably of 0.23 to 35 moles, more preferably of 0.25 to 32 moles, and more preferably of 0.28 to 0.3 moles, per mole of the trivalent framework element (e.g. Al) of the zeolite having a CHA-type framework structure. In some particular embodiments wherein copper, iron or the combination thereof is used as the promoter metal, the amount of the promoter metal is 0.1 to 1.0 moles, more preferably 0.13 to 0.8 moles, more preferably 0.15 to 0.5 moles, more preferably 0.18 to 0.4 moles, more preferably 0.2 to 0.38 moles, more preferably 0.23 to 35 moles, more preferably 0.25 to 32 moles, and more preferably 0.28 to 0.3 moles per mole of the trivalent framework element (e.g. Al) of the zeolite having a CHA-type framework structure.

In some preferable embodiments, the zeolite having a CHA-type framework structure, wherein the zeolite comprises a promoter metal M, comprises
an aluminosilicate zeolite having a CHA-type framework structure, which has a molar ratio of silica to alumina (SAR) of 10 to 25, preferably 12 to 20, and
a promoter metal present within and/or on the zeolite, which is Cu and/or Fe, particularly Cu,
   wherein the promoter metal is present at an amount of 0.2 to 0.7 moles, preferably 0.3 to 0.5 moles per mole of framework aluminum of the zeolite.

In some more preferable embodiments, the zeolite having a CHA-type framework structure, wherein the zeolite comprises a promoter metal M, according to the present invention comprises
an aluminosilicate zeolite having a CHA-type framework structure, which has a molar ratio of silica to alumina (SAR) of 12 to 20, more preferably 12 to 16, and
a promoter metal Cu present within and/or on the zeolite,
   wherein Cu is present at an amount of 0.3 to 0.5 moles per mole of framework aluminum of the zeolite.

In an exemplary embodiment, the zeolite having a CHA-type framework structure, wherein the zeolite comprises a promoter metal M, according to the present invention comprises
an aluminosilicate zeolite having a CHA-type framework structure, which has a molar ratio of silica to alumina (SAR) of 12 to 16, and
a promoter metal Cu present within and/or on the zeolite,
   wherein Cu is present at an amount of 0.3 to 0.5 moles per mole of framework aluminum of the zeolite.

Preferably, the zeolite having a CHA-type framework structure, wherein the zeolite comprises a promoter metal M, according to the present invention could exhibit NOx conversions of at least 11% at 200° C. and at least 50% at 575° C., as determined by using a Cu-promoted zeolite having a molar ratio Cu/X (e.g. Al) of 0.36 upon aging at 820° C., in a test gas stream consisting of 500 vppm NO, 500 vppm NH₃, 5 vol % H₂O, 10 vol % O₂ and balance of N₂, with gas hourly space velocity (GHSV) of 120,000 h⁻¹. Preferably, the zeolite having a CHA-type framework structure, wherein the zeolite comprises a promoter metal M, according to the present invention exhibits NOx conversions of at least 30% or at least 50% at 200° C. and at least 70% or at least 80% at 575° C., preferably as determined by using a Cu-promoted zeolite having a molar ratio Cu/X (e.g. Al) of 0.36 upon aging at 820° C.

The promoter metal may be incorporated into the zeolite having a CHA-type framework structure via any known processes, for example ion exchange and impregnation. For example, the promoter metal may be incorporated into the zeolite having a CHA-type framework structure by mixing the zeolite into a solution of a soluble precursor of the promoter metal. The zeolite upon ion-exchanging with the promoter metal typically in form of cation may be conventionally washed, dried and calcined. Useful soluble precursors of the promoter metal may be for example salts of the promoter metal, complexes of the promoter metal and a combination thereof. Alternatively, the promoter metal may be incorporated into the zeolite having a CHA-type framework structure in situ during the preparation of catalytic articles such as extrudates or coated monolith.

In the fourth aspect, the present invention provides use of the zeolite having a CHA-type framework structure obtained and/or obtainable by the process as described herein, wherein the zeolite preferably comprises a promoter metal M as described herein, in catalysts for selective catalytic reduction (SCR) of NOx, i,e, in the SCR applications.

For the SCR applications, the zeolite having a CHA-type framework structure, preferably loaded with the promoter metal as described hereinabove, may be applied in form of extrudates or in form of a washcoat on a monolithic substrate.

Accordingly, in the fifth aspect, the present invention provides a catalytic article in form of extrudates comprising an SCR catalyst composition or in form of a monolith comprising a washcoat containing an SCR catalyst composition on a substrate, wherein the SCR catalyst composition comprises the zeolite having a CHA-type framework structure, wherein the zeolite comprises a promoter metal M, as described in the third aspect.

The term “extrudates” generally refers to shaped bodies formed by extrusion. According to the present invention, the extrudates comprising the zeolite having a CHA-type framework structure and the promoter metal typically have a honeycomb structure.

The term “washcoat” has its usual meaning in the art, that is a thin, adherent coating of a catalytic or other material applied to a substrate.

The term “substrate” generally refers to a monolithic material onto which a catalytic coating is disposed, for example monolithic honeycomb substrate, particularly flow-through monolithic substrate and wall-flow monolithic substrate.

The zeolite having a CHA-type framework structure and the promoter metal may be processed into the application forms by any known processes with no particular restriction.

In a further aspect, the present invention relates to an exhaust gas treatment system comprising an internal combustion engine and an exhaust gas conduit in fluid communication with the internal combustion engine, wherein the catalytic article as described herein is present in the exhaust gas conduit.

In addition thereto, the present invention relates to a method for the selective catalytic reduction of nitrogen oxides, including
(A) providing a gas stream comprising nitrogen oxides (NOx);
(B) contacting the gas stream with a zeolite comprising a promoter metal according to any of the particular and preferred embodiments described in the present application, or with the catalytic article according to any of the particular and preferred embodiments described in the present application.

Finally, the present invention relates to the use of the zeolite having a CHA-type framework structure according to the particular and preferred embodiments described in the present application in catalysts for selective catalytic reduction of nitrogen oxides.

### EMBODIMENTS

The present invention is further illustrated by the following set of embodiments and combinations of embodiments resulting from the dependencies and back-references as indicated. In particular, it is noted that in each instance where a range of embodiments is mentioned, for example in the context of a term such as “The . . . of any one of embodiments 1 to 4”, every embodiment in this range is meant to be explicitly disclosed for the skilled person, i.e. the wording of this term is to be understood by the skilled person as being synonymous to “The . . . of any one of embodiments 1, 2, 3, and 4”. Further, it is explicitly noted that the following set of embodiments is not the set of claims determining the extent of protection, but represents a suitably structured part of the description directed to general and preferred aspects of the present invention.
1. A process for preparing a zeolite having a CHA-type framework structure, the framework structure comprising X₂O₃ and YO₂, wherein X is a trivalent element and Y is a tetravalent element, which includes
(1) preparing a synthesis mixture comprising
   (A) a source for X₂O₃,
   (B) a source for YO₂, and
   (C) a source for piperidinium cations represented by formula (I) as organic structure directing agent (OSDA),

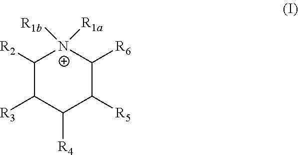

wherein
R₁ₐ is selected from C₁-C₈ alkyl and C₃-C₁₀ cycloalkyl,
R_{1b} is selected from C₂-C₈ alkyl and C₃-C₁₀ cycloalkyl, and
R₂, R₃, R₄, R₅ and R₆ independently from each other, are H, hydroxyl or C₁-C₈ alkyl; and
(2) subjecting the synthesis mixture to crystallization conditions to form a CHA zeolite.
2. The process according to Embodiment 1, wherein the piperidinium cations are represented by the following formula (I), wherein
R₁ₐ is selected from C₁-C₈ alkyl and C₃-C₁₀ cycloalkyl,
R_{1b} is selected from C₃-C₈ alkyl and C₃-C₁₀ cycloalkyl and
R₂, R₃, R₄, R₅ and R₆ independently from each other, are H, hydroxyl or C₁-C₈ alky.
3. The process according to Embodiment 1 or 2, wherein the piperidinium cations are represented by formula (Ia)

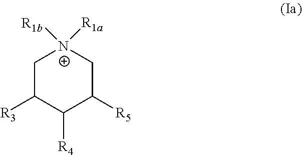

wherein
R₁ₐ is selected from C₁-C₅ alkyl and C₅-C₁₀ cycloalkyl,
R_{1b} is selected from C₃-C₅ alkyl and C₅-C₁₀ cycloalkyl, and
R₃, R₄ and R₅ independently from each other, are H, hydroxyl or C₁-C₅ alkyl.
4. The process according to Embodiment 3, wherein the piperidinium cations are represented by formula (Ia) wherein R₁ₐ is C₁-C₅ alkyl, R_{1b} is C₃-C₅ alkyl, and R₃, R₄ and R₅ independently from each other, are H, hydroxyl or C₁-C₅ alkyl.
5. The process according to Embodiment 3 or 4, wherein the piperidinium cations are represented by formula (Ia) wherein R₁ₐ is C₁-C₃ alkyl, R_{1b} is C₃-C₅ alkyl, R₃ and R₅ independently from each other are H or C₁-C₅ alkyl, and R₄ is H.
6. The process according to any of Embodiments 3 to 5, wherein the piperidinium cation are represented by formula (Ia) wherein R₁ₐ is C₁-C₃ alkyl, R_{1b} is C₃-C₅ alkyl, R₃, R₄ and R₅ are H.
7. The process according to any of Embodiments 1 to 6, wherein the piperidinium cations are selected from the group consisting of 1-methyl-1-ethylpiperidinium, 1-methyl-1-n-propylpiperidinium, 1-methyl-1-n-butylpiperidinium, 1, 1-diethylpiperidinium, 1-ethyl-1-n-propylpiperidinium, 1-ethyl-1-n-butylpiperidinium and any combinations thereof, and preferably from the group consisting of 1-methyl-1-n-propylpiperidinium, 1-methyl-1-n-butylpiperidinium, 1-ethyl-1-n-propylpiperidinium and any combinations thereof.
8. The process according to any of Embodiments 1 to 7, wherein the organic structure directing agent is in the form of salts of the piperidinium cation, wherein preferably the counterion contained in the organic structure directing agent is selected from the group consisting of halides, hydroxide, sulfate, nitrate and carboxylate, more preferably from the group consisting of fluoride, chloride, bromide, hydroxide, sulfate, nitrate, and acetate, more preferably selected from the group consisting of chloride, bromide, hydroxide and sulfate, more preferably from the group consisting of hydroxides, chlorides or bromides, wherein more preferably hydroxides of the piperidinium cations are employed.
9. The process according to any of Embodiments 1 to 8, wherein the organic structure directing agent is present in the synthesis mixture in a piperidinium:YO₂ molar ratio relative to source(s) for YO₂, calculated as YO₂, comprised in the in the range of from 0.01 to 1.0, preferably of from 0.03 to 0.5, more preferably of from 0.03 to 0.2, and more preferably of from 0.05 to 0.15.
10. The process according to any of Embodiments 1 to 9, wherein X is selected from the group consisting of Al, B, In, Ga and any combinations thereof, and Y is selected from the group consisting of Si, Sn, Ti, Zr, Ge and any combinations thereof.
11. The process according to Embodiment 10, wherein X is Al and Y is Si.
12. The process according to any of Embodiments 1 to 11, wherein the source for X₂O₃ is selected from the group consisting of alumina, aluminium hydroxide, aluminates, aluminum alkoxides, aluminum salts, FAU zeolites, LTA zeolites, LTL zeolites, BEA zeolites, MFI zeolites and any combinations thereof, preferably from the group consisting of alumina, aluminum alkoxide, aluminum salts, FAU zeolites and any combinations thereof, more preferably from the group consisting of alumina, AlO(OH), Al(OH)₃, aluminum tri(C₁-C₅) alkoxide, aluminum halides, aluminum sulfate, aluminum phosphate, aluminum fluorosilicate, FAU zeolites and any combinations thereof, more preferably from the group consisting of faujasite, [Al—Ge—O]-FAU, [Al—Ge—O]-FAU, [Ga—Al—Si—O]-FAU, [Ga—Ge—O]-FAU, [Ga—Si—O]-FAU, CSZ-1, Na—X, US—Y, ECR-30, LZ-210, Li-LSX, SAPO-37, Na—Y, ZSM-20, ZSM-3, Zeolite X and Zeolite Y, more preferably from the group consisting of faujasite, Na—X, zeolite X, zeolite Y, US—Y and LZ-210, wherein more preferably Zeolite Y is the source for X₂O₃.
13. The process according to any of Embodiments 1 to 12, wherein the sources for X₂O₃ and YO₂ comprise FAU zeolites, particularly zeolite Y, more preferably zeolite Y having a molar ratio of XO₂ to Y₂O₃ of no more than 40, preferably of no more than 30, more preferably of no more than 20, and even more preferably of no more than 10.
14. The process according to Embodiment 13, wherein an additional source for YO₂ is used, wherein the additional source for YO₂ is preferably selected from the group consisting of fumed silica, precipitated silica, silica hydrosols, silica gels, and colloidal silica, including mixtures of two or more thereof.
15. The process according to any of Embodiments 1 to 14, wherein the source for YO₂ is selected from the group consisting of fumed silica, precipitated silica, silica hydrosols, silica gels, colloidal silica, silicic acid, silicon alkoxides, alkali metal silicates, sodium metasilicate hydrate, sesquisilicate, disilicate, silicic acid esters, FAU zeolites, LTA zeolites, LTL zeolites, BEA zeolites, MFI zeolites and any combinations thereof, preferably from the group consisting of fumed silica, precipitated silica, silica hydrosols, silica gels, colloidal silica faujasite, [Al—Ge—O]-FAU, [Al—Ge—O]-FAU, [Ga—Al—Si—O]-FAU, [Ga—Ge—O]-FAU, [Ga—Si—O]-FAU, CSZ-1, Na—X, US—Y, ECR-30, LZ-210, Li-LSX, SAPO-37, Na—Y, ZSM-20, ZSM-3, Zeolite X and Zeolite Y, more preferably from the group consisting of faujasite, Na—X, zeolite X, zeolite Y, US—Y, and LZ-210, and more preferably from the group consisting of fumed silica, precipitated silica, silica hydrosols, silica gels, colloidal silica and zeolite Y.
16. The process according to any of Embodiments 1 to 15, wherein the mixture prepared in step (1) has a YO₂:X₂O₃ molar ratio of the source for YO₂ calculated as YO₂ to the source for X₂O₃ calculated as X₂O₃, which is comprised in the range of from 5 to 100, preferably of from 15 to 80, more preferably of from 15 to 60, more preferably of from 15 to 40, more preferably of from 15 to 35, and more preferably of from 15 to 30.
17. The process according to any of Embodiments 1 to 16, wherein the synthesis mixture comprises no organic structure directing agent cations other than the piperidinium cations.
18. The process according to any of Embodiments 1 to 17, wherein the mixture prepared in step (1) further comprises a source for alkali metal and/or alkaline earth metal cations (AM), preferably a source for alkali metal cations, wherein the alkali metal is preferably selected from the group consisting of Li, Na, K, Cs and any combinations thereof, wherein more preferably the alkali metal is Na and/or K, preferably Na.
19. The process according to Embodiment 18, wherein the alkaline earth metal is preferably selected from the group consisting of Mg, Ca, Sr and Ba and any combinations thereof.
20. The process according to Embodiment 18 or 19, wherein the sources for alkali metal and/or alkaline earth metal cations (AM) are selected from the group consisting of halides, hydroxide, sulfate, nitrate and carboxylate, more preferably from the group consisting of fluoride, chloride, bromide, hydroxide, sulfate, nitrate, and acetate, more preferably selected from the group consisting of chloride, bromide, hydroxide and sulfate, more preferably from the group consisting of hydroxides, chlorides or bromides, wherein more preferably hydroxides of the piperidinium cations are employed.
21. The process according to any of Embodiments 18 to 20, wherein the alkali metal and/or alkaline earth metal cations (AM) are contained in the synthesis mixture in an AM:YO₂ molar ratio relative to the source(s) for YO₂ in the synthesis mixture, calculated as YO₂, in the range of from 0.01 to 1.0, preferably of from 0.1 to 1.0, more preferably of from 0.3 to 0.8, and more preferably of from 0.5 to 0.7.
22. The process according to any of Embodiments 1 to 21, wherein the synthesis mixture prepared in step (1) further comprises a source for the anion OH⁻, wherein the source is preferably a metal hydroxide or ammonium hydroxide, wherein more preferably the source is selected from the group consisting of alkali metal hydroxides, alkaline earth metal hydroxides, and ammonium hydroxide.
23. The process according to Embodiment 22, wherein the source for the anion OH⁻ is the organic structure directing agent.
24. The process according to Embodiment 22 or 23, wherein the OH⁻ anions are present in the synthesis mixture in an OH⁻:YO₂ molar ratio relative to the source(s) for YO₂, calculated as YO₂, comprised in the range of from 0.1 to 2.0, preferably of from 0.2 to 1.0, and more preferably of from 0.5 to 1.0.
25. The process according to any of Embodiments 1 to 24, wherein the mixture prepared in step (1) further comprises at least one solvent, preferably water, and more preferably deionized water.
26. The process according to Embodiment 25, wherein the solvent is comprised in one or more of the starting materials of the synthesis mixture and/or may be added separately to the synthesis mixture.
27. The process according to any of Embodiments 1 to 26, wherein the synthesis mixture has an H₂O:YO₂ molar ratio of water to the source(s) for YO₂, calculated as YO₂, comprised in the range of from 3 to 100, more preferably of from 10 to 80, more preferably of from 20 to 70, and more preferably of from 30 to 60.
28. The process according to any of Embodiments 1 to 27, wherein the synthesis mixture prepared in step (1) further comprises seed crystals of CHA zeolite, wherein preferably the seed crystals of CHA zeolite are obtainable or obtained according to the process of any of Embodiments 1 to 27 and 29 to 40 without using seed crystals.
29. The process according to any of Embodiments 1 to 28, wherein crystallization in step (2) is conducted at a temperature in the range of from 80 to 250° C., preferably of from 100 to 200° C.
30. The process according to any of Embodiments 1 to 29, wherein crystallization in step (2) is conducted for a duration in the range of from 0.5 to 12 days, preferably of from 1 to 6 days.
31. The process according to any of Embodiments 1 to 30, wherein crystallization in step (2) is conducted under autogenous pressure.
32. The process according to any of Embodiments 1 to 31, wherein crystallization in step (2) is conducted in a pressure tight vessel, preferably in an autoclave.
33. The process according to any of Embodiments 1 to 32, wherein crystallization in step (2) is conducted with or without agitation of the synthesis mixture.
34. The process according to any of Embodiments 1 to 33, wherein step (2) further comprises subjecting the CHA zeolite to a work-up procedure including isolating, optionally washing, and drying the CHA zeolite, wherein isolating is preferably achieved by filtration.
35. The process according to any of Embodiments 1 to 34, wherein the process further comprises (3) calcination of the as-synthesized CHA zeolite.
36. The process according to any of Embodiments 1 to 35, wherein the process further comprises (4) exchanging one or more ionic non-framework elements contained in the CHA zeolite obtained in step (2) or (3) against H⁺ and/or NH₄⁺, preferably against NH₄⁺.
37. The process according to Embodiment 36, wherein step (4) further comprises subjecting the ion-exchanged CHA zeolite to a work-up procedure including isolating, optionally washing, and drying and/or calcination of the ion-exchanged CHA zeolite, wherein isolating is preferably achieved by filtration.
38. The process according to any of Embodiments 35 to 37, wherein calcination in step (3) and/or step (4) is conducted at a temperature comprised in the range of from 300 to 900° C., preferably of from 350 to 700° C., and more preferably of from 400 to 650° C.
39. The process according to any of Embodiments 35 to 38, wherein calcination in step (3) and/or step (4) is conducted in a gas atmosphere, wherein the gas atmosphere preferably comprises, and more preferably consists of, air, oxygen, nitrogen, or a mixture of two or more thereof.
40. The process according to any of Embodiments 35 to 39, wherein calcination in step (3) and/or step (4) is conducted for a period in the range of from 0.5 to 10 hours, preferably of from 3 to 7 hours, and more preferably of from 4 to 6 hours.
41. A zeolite having a CHA-type framework structure obtained and/or obtainable by the process according to any of Embodiments 1 to 40.
42. A zeolite having a CHA-type framework structure, which, preferably in the as-synthesized form, comprises the piperidinium cations as defined in any of preceding Embodiments 1 to 7 within its pores and/or channels.
43. The zeolite according to Embodiment 41 or 42, which has a YO₂:X₂O₃ molar ratio of 2 or more, wherein the YO₂:X₂O₃ molar ratio is preferably comprised in the range of from 4 to 200, more preferably of from 6 to 100, more preferably of from 8 to 50, more preferably of from 10 to 35, more preferably of from 11 to 25, more preferably of from 11.5 to 20, more preferably of from 12 to 16, more preferably of from 12.5 to 15, and more preferably of from 13 to 14.
44. The zeolite according to any of Embodiments 41 to 43, wherein the zeolite has an average crystal size of up to 2 μm, preferably up to 1.5 μm, wherein more preferably the average crystal size is in the range of from 200 nm to 1.5 μm.
45. The zeolite according to any of Embodiments 41 to 44, wherein the zeolite has a mesopore surface area (MSA) of no more than 60 m²/g, preferably of no more than 50 m²/g, more preferably of no more than 45 m²/g, wherein more preferably the mesopore surface area of the zeolite is comprised in the range of from 1 to 50 m²/g, and more preferably of from 3 to 40 m²/g.
46. The zeolite according to any of Embodiments 41 to 45, wherein the zeolite has a zeolitic surface area (ZSA) of at least 400 m²/g, preferably of at least 450 m²/g, wherein more preferably the zeolitic surface area of the zeolite is comprised in the range of from in the range of 450 to 650 m²/g, and more preferably of from 450 to 600 m²/g, wherein the zeolitic surface area is preferably the BET surface area of the zeolite, preferably as determined according to ISO 9277:2010.
47. The zeolite according to any of Embodiments 41 to 46, wherein the zeolite is at least 90% phase pure as determined by X-ray powder diffraction (XRD) analysis, preferably at least 95% phase pure, more preferably at least 98% phase pure, and more preferably at least 99% phase pure.
48. The zeolite according to any of Embodiments 41 to 47, wherein the zeolite contains less than 10% of a framework structure type other than CHA as a separate phase and/or as intergrowth as determined by X-ray powder diffraction (XRD) analysis, preferably less than 5%, more preferably less than 2%, and more preferably less than 1%.
49. The zeolite according to any of Embodiments 41 to 48, wherein the zeolite comprises a promoter metal M.
50. The zeolite according to Embodiments 49, wherein the promoter metal is selected from transition metals, alkali earth metals, Sb, Sn and Bi, and any combinations thereof, preferably comprising Cu and/or Fe, preferably Cu.
51. The zeolite according to Embodiment 49 or 50, wherein the promoter metal consists of Cu and/or Fe, preferably of Cu.
52. The zeolite according to any of Embodiments 49 to 51, wherein the promoter metal is contained within and/or on the surface of the zeolite.
53. The zeolite according to any of Embodiments 49 to 52, wherein the promoter metal is contained at the ion-exchange sites of the zeolite.
54. The zeolite according to any of Embodiments 49 to 53, wherein the zeolite comprises the promoter metal in an amount comprised in the range of from 0.1 to 10% by weight calculated as the oxide of the promoter metal and based on the total weight of the zeolite, preferably of from 0.5 to 10% by weight.
55. The zeolite according to any of Embodiments 49 to 54, wherein copper and/or iron is used as the promoter metal, and the promoter metal is comprised in the zeolite in and amount comprised in the range of from 1 to 8% by weight, calculated as CuO and/or Fe₂O₃ and based on the total weight of the zeolite, preferably of from 2 to 7% by weight.
56. The zeolite according to any of Embodiments 49 to 55, wherein the M:X molar ratio of the promoter metal to the trivalent element X in the zeolitic material is comprised in the range of from 0.01 to 2, preferably of from 0.03 to 1.8, more preferably of from 0.05 to 1.5, more preferably of from 0.08 to 1.2, more preferably of from 0.1 to 1.0, more preferably of from 0.13 to 0.8, more preferably of from 0.15 to 0.5, more preferably of from 0.18 to 0.4, more preferably of from 0.2 to 0.38, more preferably of from 0.23 to 35, more preferably of from 0.25 to 32, and more preferably of from 0.28 to 0.3.
57. The zeolite comprising a promoter metal according to any of Embodiments 49 to 56, which exhibits NOx conversions of at least 11% at 200° C. and at least 50% at 575° C. upon steam aging with 10% H₂O at 820° C., in a test gas stream consisting of 500 vppm NO, 500 vppm NH₃, 5 vol % H₂O, 10 vol % O₂ and balance of N₂, with gas hourly space velocity (GHSV) of 120,000 h⁻¹.
58. A catalytic article in form of extrudates comprising an SCR catalyst composition or in form of a monolith comprising a washcoat containing an SCR catalyst composition on a substrate, wherein the SCR catalyst composition comprises a zeolite comprising a promoter metal according to any of Embodiments 49 to 57.
59. An exhaust gas treatment system, which comprises an internal combustion engine and an exhaust gas conduit in fluid communication with the internal combustion engine, wherein the catalytic article according to Embodiment 58 is present in the exhaust gas conduit.
60. Use of the zeolite having a CHA-type framework structure according to any of Embodiments 41 to 57 in catalysts for selective catalytic reduction of nitrogen oxides.
61. A method for the selective catalytic reduction of nitrogen oxides, including
(A) providing a gas stream comprising nitrogen oxides (NOx);
(B) contacting the gas stream with a zeolite comprising a promoter metal according to any of Embodiments 49 to 57 or the catalytic article according to Embodiment 58.

The invention will be further illustrated by following Examples, which set forth particularly advantageous embodiments. While the Examples are provided to illustrate the present invention, they are not intended to limit the present invention.

### EXAMPLES

Scanning electron microscopy (SEM) measurements were performed by a scanning electron microscope (Hitachi SU1510).

X-ray powder diffraction (XRD) patterns were measured with PANalytical X'pert³ Powder Diffractometer (40 kV, 40 mA) using CuKα(λ=1.5406 Å) radiation to collect data in Bragg-Brentano geometry.

### Example 1 Preparation of Zeolite With 1-methyl-1-n-propylpiperidinium Hydroxide as the OSDA (Zeolite A, Calcined H-Form)

814.6 g of an aqueous solution of 1-methyl-1-n-propylpiperidinium hydroxide (12.6 wt %) was mixed with 2814.3 g of D.I. water, followed by addition of 110.8 g of sodium hydroxide (99%, solid). After sodium hydroxide dissolved, 44.9 g of Zeolite HY (SAR=7.2, from Shandong Duoyou) and 567.6 g of Ludox® AS-40 colloidal silica were added. After stirring at room temperature for 30 mins, the synthesis mixture was transferred into an autoclave with Teflon liner for crystallization. The crystallization was carried out at 150° C. for 5 days under static condition. After cooling to room temperature, the zeolite product was collected by filtration and dried at 120° C. overnight. Elemental analysis of the as-synthesized zeolite indicates 11.51% C and 1.46% N (C/N molar ratio=9.17).

The as-synthesized zeolite was calcined at 550° C. for 6 hours to remove the organic structure directing agent. The calcined zeolite was crushed and ion-exchanged in a 10 wt % aqueous NH₄Cl solution at a solid/liquid ratio of 1:10. The ion exchange process was carried out at 80° C. for 2 hours, collected by filtration, washed with D.I. water, dried at 110° C. overnight. The ion-exchange procedure was repeated once and the dried product was calcined at 450° C. for 6 hours to obtain the calcined H-form zeolite.

The zeolite having a SiO₂/Al₂O₃ molar ratio of (SAR) of 14.2 as measured on the calcined H-form by XRF, a mesopore surface area (MSA) of 20 m²/g and a zeolitic surface area (ZSA) of 508 m²/g, as measured on the calcined H-form.

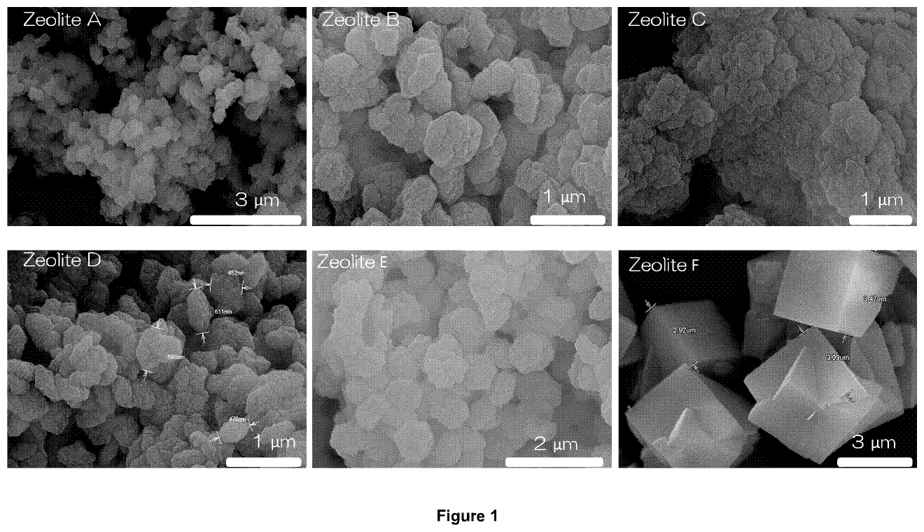

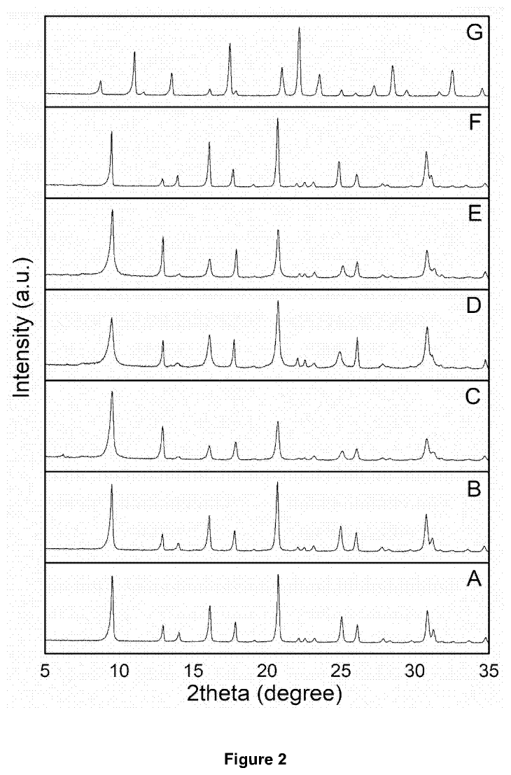

The crystal morphology of the zeolite observed from the SEM image and the XRD pattern of the zeolite are shown in FIG. 1 and FIG. 2 respectively. It was confirmed by the XRD pattern that the zeolite has a typical CHA framework.

### Example 2 Preparation of Zeolite With 1-methyl-1-n-propylpiperidinium Hydroxide as the OSDA (Zeolite B, Calcined H-Form)

500.1 g of an aqueous solution of 1-methyl-1-n-propylpiperidinium hydroxide (12.6 wt %) was mixed with 2628.2 g of D.I. water, followed by addition of 169.8 g of sodium hydroxide (99%, solid). After sodium hydroxide dissolved, 103.3 g of Zeolite HY (SAR=7.2, from Shandong Duoyou) and 811.8 g of Ludox® AS-40 colloidal silica were added. After stirring at room temperature for 30 mins, the synthesis mixture was transferred into an autoclave with Teflon liner for crystallization. The crystallization was carried out at 150° C. for 3 days under static condition. After cooling to room temperature, the zeolite product was collected by filtration and dried at 120° C. overnight. Elemental analysis of the as-synthesized zeolite indicates 9.88% C and 1.32% N (C/N molar ratio=8.73).

The as-synthesized zeolite was calcined at 550° C. for 6 hours to remove the organic structure directing agent. The calcined zeolite was crushed and ion-exchanged in a 10 wt % aqueous NH₄Cl solution at a solid/liquid ratio of 1:10. The ion exchange process was carried out at 80° C. for 2 hours, collected by filtration, washed with D.I. water, dried at 110° C. overnight. The ion-exchange procedure was repeated once and the dried product was calcined at 450° C. for 6 hours to obtain the calcined H-form zeolite.

The zeolite having a SiO₂/Al₂O₃ molar ratio of (SAR) of 12.5 as measured on the calcined H-form by XRF, a mesopore surface area (MSA) of 12 m²/g and a zeolitic surface area (ZSA) of 531 m²/g, as measured on the calcined H-form.

The crystal morphology of the zeolite observed from the SEM image and the XRD pattern of the zeolite are shown in FIG. 1 and FIG. 2 respectively. It was confirmed by the XRD pattern that the zeolite has a typical CHA framework.

### Example 3 Preparation of Zeolite With 1-methyl-1-n-propylpiperidinium Hydroxide as the OSDA (Zeolite C, Calcined H-Form)

500.1 g of an aqueous solution of 1-methyl-1-n-propylpiperidinium hydroxide (12.6 wt %) was mixed with 2472.2 g of D.I. water, followed by addition of 169.8 g of sodium hydroxide (99%, solid). After sodium hydroxide dissolved, 103.3 g of Zeolite HY (SAR=7.2, from Sinopec) and 811.8 g of sodium silicate were added. After stirring at room temperature for 30 mins, the synthesis mixture was transferred into an autoclave with Teflon liner for crystallization. The crystallization was carried out at 150° C. for 3 days under static condition. After cooling to room temperature, the zeolite product was collected by filtration and dried at 120° C. overnight.

The as-synthesized zeolite was calcined at 550° C. for 6 hours to remove the organic structure directing agent. The calcined zeolite was crushed and ion-exchanged in a 10 wt % aqueous NH₄Cl solution at a solid/liquid ratio of 1:10. The ion exchange process was carried out at 80° C. for 2 hours, collected by filtration, washed with D.I. water, dried at 110° C. overnight. The ion-exchange procedure was repeated once and the dried product was calcined at 450° C. for 6 hours to obtain the calcined H-form zeolite.

The zeolite having a SiO₂/Al₂O₃ molar ratio of (SAR) of 11.5 as measured on the calcined H-form by XRF, a mesopore surface area (MSA) of 10 m²/g and a zeolitic surface area (ZSA) of 545 m²/g, as measured on the calcined H-form.

The crystal morphology of the zeolite observed from the SEM image and the XRD pattern of the zeolite are shown in FIG. 1 and FIG. 2 respectively. It was confirmed by the XRD pattern that the zeolite has a typical CHA framework.

### Example 4 Preparation of Zeolite With 1-methyl-1-n-butyl-piperidinium Hydroxide as the OSDA (Zeolite D, Calcined H-Form)

718.4 g of an aqueous solution of 1-methyl-1-n-butyl-piperidinium hydroxide (9.7 wt %) was mixed with 2431.6 g of D.I. water, followed by addition of 172.7 g of sodium hydroxide (99%, solid). After sodium hydroxide dissolved, 69.9 g of Zeolite HY (SAR=7.2, from Shandong Duoyou) and 884.4 g of Ludox® AS-40 colloidal silica were added. After stirring at room temperature for 30 mins, the synthesis mixture was transferred into an autoclave with Teflon liner for crystallization. The crystallization was carried out at 150° C. for 3 days under static condition. After cooling to room temperature, the zeolite product was collected by filtration and dried at 120° C. overnight.

The as-synthesized zeolite was calcined at 550° C. for 6 hours to remove the organic structure directing agent. The calcined zeolite was crushed and ion-exchanged in a 10 wt % aqueous NH₄Cl solution at a solid/liquid ratio of 1:10. The ion exchange process was carried out at 80° C. for 2 hours, collected by filtration, washed with D.I. water, dried at 110° C. overnight. The ion-exchange procedure was repeated once and the dried product was calcined at 450° C. for 6 hours to obtain the calcined H-form zeolite.

The zeolite having a SiO₂/Al₂O₃ molar ratio of (SAR) of 13.9 as measured on the calcined H-form by XRF, a mesopore surface area (MSA) of 37 m²/g, a zeolitic surface area (ZSA) of 515 m²/g, as measured on the calcined H-form.

The crystal morphology of the zeolite observed from the SEM image and the XRD pattern of the zeolite are shown in FIG. 1 and FIG. 2 respectively. It was confirmed by the XRD pattern that the zeolite has a typical CHA framework.

### Example 5 Preparation of Zeolite With 1-ethyl-1-n-propylpiperidinium Hydroxide as the OSDA (Zeolite E, Calcined H-Form)

893.5 g of an aqueous solution of 1-ethyl-1-n-propylpiperidinium hydroxide (7.9 wt %) was mixed with 2335.3 g of D.I. water, followed by addition of 169.5 g of sodium hydroxide (99%, solid). After sodium hydroxide dissolved, 106.5 g of Zeolite HY (SAR=7.2, from Shandong Duoyou) and 836.4 g of Ludox® AS-40 colloidal silica were added. After stirring at room temperature for 30 mins, the synthesis mixture was transferred into an autoclave with Teflon liner for crystallization. The crystallization was carried out at 150° C. for 3 days under static condition. After cooling to room temperature, the zeolite product was collected by filtration and dried at 120° C. overnight.

The as-synthesized zeolite was calcined at 550° C. for 6 hours to remove the organic structure directing agent. The calcined zeolite was crushed and ion-exchanged in a 10 wt % aqueous NH₄Cl solution at a solid/liquid ratio of 1:10. The ion exchange process was carried out at 80° C. for 2 hours, collected by filtration, washed with D.I. water, dried at 110° C. overnight. The ion-exchange procedure was repeated once and the dried product was calcined at 450° C. for 6 hours to obtain the calcined H-form zeolite.

The zeolite having a SiO₂/Al₂O₃ molar ratio of (SAR) of 12.3 as measured on the calcined H-form by XRF, a mesopore surface area (MSA) of 20 m²/g, a zeolitic surface area (ZSA) of 530 m²/g, as measured on the calcined H-form.

The crystal morphology of the zeolite observed from the SEM image and the XRD pattern of the zeolite are shown in FIG. 1 and FIG. 2 respectively. It was confirmed by the XRD pattern that the zeolite has a typical CHA framework.

### Example 6 Preparation of Zeolite With N,N, N-trimethyl-1-adamantyl Ammonium Hydroxide as the OSDA (Zeolite F, Calcined H-Form)

To a solution of 0.5 g of sodium hydroxide (99%, solid) in 35 g of D.I. water, 95 g of sodium silicate, 3 g of sodium sulfate (99%, solid) and then 9 g of Zeolite Na—Y (SAR=5.1, CBV 100 from Zeolyst) were added. Then, 16 g of an aqueous solution of N,N,N-trimethyl-1-adamantyl ammonium hydroxide (20 wt %) was added, and stirred at room temperature for 30 mins. The synthesis mixture was then transferred into an autoclave with Teflon liner for crystallization. The crystallization was carried out at 140° C. for 3 days under static condition. After cooling to room temperature, the zeolite product was collected by filtration and dried at 120° C. overnight.

The as-synthesized zeolite was calcined at 550° C. for 6 hours to remove the organic structure directing agent. The calcined zeolite was crushed and ion-exchanged in a 10 wt % aqueous NH₄Cl solution at a solid/liquid ratio of 1:10. The ion exchange process was carried out at 80° C. for 2 hours, collected by filtration, washed with D.I. water, dried at 110° C. overnight. The ion-exchange procedure was repeated once and the dried product was calcined at 450° C. for 6 hours to obtain the calcined H-form zeolite.

The zeolite having a SiO₂/Al₂O₃ molar ratio of (SAR) of 11.4 as measured on the calcined H-form by XRF, a mesopore surface area (MSA) of 11 m²/g, a zeolitic surface area (ZSA) of 512 m²/g, as measured on the calcined H-form.

The crystal morphology of the zeolite observed from the SEM image and the XRD pattern of the zeolite are shown in FIG. 1 and FIG. 2 respectively. It was confirmed by the XRD pattern that the zeolite has a typical CHA framework.

### Example 7 Preparation of Zeolite With 1,1-dimethyl Piperidinium Hydroxide as the OSDA (Zeolite G, Calcined H-Form)

16.4 g of an aqueous solution of 1,1-dimethylpiperidinium hydroxide (20 wt %) was mixed with 9.7 g of D.I. water, followed by addition of 3.0 g of sodium hydroxide (99%, solid). After sodium hydroxide dissolved, 2.0 g of Zeolite HY (SAR=7.2, from Shandong Duoyou) and 16.8 g of Ludox® AS-40 colloidal silica were added. After stirring at room temperature for 30 mins, the synthesis mixture was transferred into an autoclave with Teflon liner for crystallization. The crystallization was carried out at 170° C. for 2 days under static condition. After cooling to room temperature, the zeolite product was collected by filtration and dried at 120° C. overnight.

The as-synthesized zeolite was calcined at 550° C. for 6 hours to remove the organic structure directing agent. The calcined zeolite was crushed and ion-exchanged in a 10 wt % aqueous NH₄Cl solution at a solid/liquid ratio of 1:10. The ion exchange process was carried out at 80° C. for 2 hours, collected by filtration, washed with D.I. water, dried at 110° C. overnight. The ion-exchange procedure was repeated once and the dried product was calcined at 450° C. for 6 hours to obtain the calcined H-form zeolite.

As confirmed by XRD, a zeolite having LEV framework was obtained. It has been found that zeolite having a CHA-type framework cannot be obtained with 1,1-dimethyl piperidinium hydroxide as the OSDA according to the present synthesis method.

### Example 8 Preparation of Cu-Loaded CHA Zeolite Material (SCR Catalyst)

The H-form zeolite powder as obtained was impregnated with an aqueous copper (II) nitrate solution by incipient wetness impregnation and maintained at 50° C. for 20 hours in a sealed container. The obtained solid was dried and calcined in air in a furnace at 450° C. for 5 hours, to obtain Cu-loaded CHA zeolites.

The Cu-loaded CHA zeolites as prepared in accordance with the above general procedure are summarized in the Table 2 below.

TABLE 2

| | | Cu Loading, wt % | Cu/Al |
|---|---|---|---|
| Sample | | on oxide basis, | molar ratio, |
| No. | Zeolite from | as measured by ICP | theoretical |
| A.1 | Example 1 | 5.1 | 0.32 |
| A.2 | Example 1 | 5.7 | 0.36 |
| A.3 | Example 1 | 6.3 | 0.4 |
| B.1 | Example 2 | 5.7 | 0.32 |
| B.2 | Example 2 | 6.3 | 0.36 |
| B.3 | Example 2 | 6.9 | 0.4 |
| C.1 | Example 3 | 6.1 | 0.32 |
| C.2 | Example 3 | 6.8 | 0.36 |
| C.3 | Example 3 | 7.5 | 0.4 |
| D.1 | Example 4 | 5.2 | 0.32 |
| D.2 | Example 4 | 5.8 | 0.36 |
| D.3 | Example 4 | 6.4 | 0.4 |
| E.1 | Example 5 | 5.7 | 0.32 |
| E.2 | Example 5 | 6.4 | 0.36 |
| F | Example 6 | 7 | 0.36 |

### Example 9 Test of Catalyst Performance

For test of SCR performance, the Cu-loaded zeolite materials were slurried with an aqueous solution of Zr-acetate and then dried at ambient temperature in air under stirring, and calcined at 550° C. for 1 hour to provide a product containing 5wt % ZrO₂ as the binder based on the amount of the product. The product was crushed and the powder fraction of 250 to 500 microns was used for the test. The obtained powder was aged at 650° C. for 50 hours or 820° C. for 16 hours in a flow of 10 vol % steam/air to provide aged samples.

The selective catalytic reduction (SCR) test was carried out in a fixed-bed reactor with loading of 80 mg of the test sample together with corundum of the same sieve fraction as diluent to about 1 mL bed volume, in accordance with following conditions:
Gas feed: 500 vppm NO, 500 vppm NH₃, 5 vol % H₂O, 10 vol % O₂ and balance of N₂, with gas hourly space velocity (GHSV) of 120,000 h⁻¹;
Temperature: RUN1-200, 400, 575° C. (first run for degreening)
   RUN2-175, 200, 225, 250, 500, 550, 575° C.

NOx conversions as measured from RUN 2 at 200° C. and 575° C. are reported as the test results.

Results of the test samples aged at 650° C. and aged at 820° C. are summarized in Table 3 below.

TABLE 3

| | Aged @650° C. | | Aged @820° C. | |
|---|---|---|---|---|
| Sam- | NOx | NOx | NOx | NOx |
| ple | conversion @ | conversion @ | conversion @ | conversion @ |
| No. | 200° C., % | 575° C., % | 200° C., % | 575° C., % |
| A.1 | 82 | 94 | 73 | 89 |
| A.2 | 82 | 91 | 73 | 86 |
| A.3 | 79 | 89 | 74 | 77 |
| B.1 | 79 | 96 | 72 | 88 |
| B.2 | 82 | 96 | 74 | 87 |
| B.3 | 81 | 89 | 75 | 87 |
| C.1 | 83 | 95 | 70 | 87 |
| C.2 | 82 | 93 | 11 | 56 |
| C.3 | 87 | 92 | 3 | 8 |
| D.1 | 68 | 94 | 68 | 88 |
| D.2 | 72 | 92 | 71 | 82 |
| D.3 | 72 | 93 | 68 | 82 |
| E.1 | 70 | 88 | 69 | 89 |
| E.2 | 75 | 91 | 69 | 80 |
| F | 73 | 92 | 0 | 0 |

It can be seen that the catalysts comprising Cu-loaded CHA zeolite according to the present invention are effective for selective catalytic reduction (SCR) of nitrogen oxides after aging at high temperatures.

Upon aging at 650° C., the inventive catalysts based on the CHA zeolites A to E as prepared with the piperidinium cation based OSDA (Examples 1 to 5) exhibit at least comparable NOx conversions, compared with the comparative catalyst F at the same Cu/Al ratio but prepared using different OSDA (Example 6).

Surprisingly, upon aging at 820° C., the inventive catalysts exhibit greatly improved NOx conversions compared with the comparative catalyst F. The inventive catalysts upon aging at 820° C. resulted in NOx conversions at 200° C. of at least 11%, even up to 75%, and resulted in NOx conversions at 575° C. of at least 56%, even up to 89%, while the NOx conversions in case of corresponding comparative catalyst are “0”. The comparatively high SCR activity of the inventive catalysts after aging at 820° C. reflects high stability of the CHA zeolite at an extremely high temperature.

Furthermore, it has surprisingly been found from the catalyst testing in SCR that—depending on the specific template which is employed—the hydrothermal stability of the inventive samples may depend on both the SiO₂:Al₂O₃ molar ratio as well as on the Cu:Al molar ratio. Thus, as may be taken from the results shown in Table 3 for the catalyst samples A-C, the hydrothermal stability gradually decreases with decreasing SiO₂:Al₂O₃ molar ratio, wherein from sample A to C the SiO₂: Al₂O₃ molar ratio decreases from 14.2 to 11.5. In addition thereto, as may be taken from the results for Zeolite C, the increase of the Cu:Al molar ratio from 0.32 in sample no. C.1 to 0.4 in sample C.3 leads to a drastic decrease in hydrothermal stability, as may be observed by the NOx conversion rates after aging at 820° C.

The catalysts comprising the Cu-loaded CHA zeolite according to the present invention were also tested with respect to sulfur-resistance in accordance with the following procedures.

### Sulfurization

A piece of Pt-containing Diesel Oxidation Catalyst (DOC, 0.6 wt % Pt supported on aluminosilicate) with a size of 3″ (diameter)×2″ (length) was placed upstream of 200 mg of the Cu-loaded CHA catalyst powder in a column reactor. A gas stream containing 8 vol % H₂O, 10 vol % O₂, 7 vol % CO₂ and balance of N₂ was fed through the reactor with heating at 10 K/min, and maintained at a temperature of 400° C. for 1 hour. Subsequently, the feed was switched to a gas stream containing 35 ppmv SO₂, 10 vol % O₂, 8 vol % H₂O, 7 vol % CO₂ and balanced N₂ at a space velocity of 10,000 hr⁻¹ based on the volume of the SCR catalyst for a period of time to produce 22.7 mg S per 100 mg of the sample. The reactor was cooled to 150° C. by switching the feed to the gas stream containing 8 vol % H₂O, 10 vol % O₂, 7 vol % CO₂ and balance of N₂, and then cooled down by switching the feed to the gas stream containing 10 vol % O₂ and balance of N₂.

### Desulfurization (Regeneration)

A gas stream containing 10 vol % O₂, 8 vol % H₂O, 7 vol % CO₂ and balanced N₂ was passed through the sulfurized SCR catalyst at a space velocity of 60,000 h⁻¹, 550° C. for 30 minutes, to provide a desulfurized SCR catalyst. The reactor was cooled down in the same manner as described for sulfurization.

The SCR test was carried out in a fixed-bed reactor with loading of 120 mg of the test sample together with corundum of the same sieve fraction as diluent to about 1 mL bed volume, with a gas feed of 500 vppm NO, 525 vppm NH₃, 8 vol % H₂O, 10 vol % O₂, 7 vol % CO₂ and balance of N₂, with gas hourly space velocity (GHSV) of 60,000 h⁻¹. Results are summarized in Table 4 below.

TABLE 4

| | |
|---|---|
| Aged @650° C. | Aged @820° C. |

| | |
|---|---|
| Sample | NOx conversions, % |

| | | | | |
|---|---|---|---|---|
| No. | 225° C. | 575° C. | 225° C. | 575° C. |

before sulfurization

| | | | | |
|---|---|---|---|---|
| A.2 | 99.4 | 88.0 | 97.6 | 75.5 |
| B.2 | 99.6 | 91.0 | 95.1 | 74.5 |
| C.2 | 99.3 | 92.4 | 9.6 | 31.6 |

after regeneration

| | | | | |
|---|---|---|---|---|
| A.2 | 85.7 | 80.9 | 65.9 | 65.4 |
| B.2 | 78.6 | 84.5 | 57.2 | 66.6 |
| C.2 | 75.5 | 79.5 | 2.3 | 7.4 |

The catalysts comprising the Cu-loaded CHA zeolite according to the present invention exhibit acceptable sulfur resistance. With regard to the results obtained for sample no. C.2 after aging at 820° C., reference is made to the effects described in the foregoing section relative to the results shown in Table 4 and the dependence of the hydrothermal stability of the inventive samples on both the SiO₂:Al₂O₃ molar ratio as well as on the Cu:Al molar ratio.

### Example 10 Preparation of Fe-Loaded CHA Zeolite and Test of Catalyst Performance

Two Fe-loaded CHA zeolites were prepared in accordance with the same process as described in Example 8 except that an aqueous iron (III) nitrate solution was used for the incipient wetness impregnation to obtain a Fe-loaded zeolite. The Fe-loaded CHA zeolites as prepared are summarized in Table 5 below.

TABLE 5

| | | Fe Loading, wt % | Fe/Al |
|---|---|---|---|
| Sample | | on oxide basis, | molar ratio, |
| No. | Zeolite from | as measured by ICP | theoretical |
| A.4 | Example 1 | 4.1 | 0.25 |
| C.4 | Example 3 | 4.6 | 0.25 |

The test sample of the catalyst comprising the Fe-loaded CHA zeolite was prepared in accordance with the same process as described in Example 9 except the powder was aged at 650° C. for 50 hours.

The SCR test was carried out carried out in a fixed-bed reactor with loading of 120 mg of the test sample together with corundum of the same sieve fraction as diluent to about 1 mL bed volume, in accordance with following conditions:
Gas feed (standard SCR): 500 vppm NO, 500 vppm NH₃, 5 vol % H₂O, 10 vol % O₂ and balance of N₂, with gas hourly space velocity (GHSV) of 60,000 h⁻¹;
   RUN1-200, 400, 575° C. (first run for degreening)
   RUN2-175, 200, 225, 250, 500, 550, 575° C.
Gas feed (fast SCR): 250 vppm NO, 250 vppm NO₂, 500 vppm NH₃, 5 vol % H₂O, 10 vol % O₂ and balance of N₂, with gas hourly space velocity (GHSV) of 80,000 h⁻¹
   RUN3-575, 550, 450, 350, 250, 225, 200, 175° C.

The results are summarized in Table 6 below.

TABLE 6

| | | | | | | | |
|---|---|---|---|---|---|---|---|
| Sample | 200° | 225° | 250° | 350° | 450° | 550° | 575° |
| No. | C. | C. | C. | C. | C. | C. | C. |

NOx conversions before sulfurization, %
Standard SCR

| | | | | | | | |
|---|---|---|---|---|---|---|---|
| A.4 | 8.2 | 17.3 | 31.7 | 79.5 | 89.2 | 89.7 | 90.3 |
| C.4 | 5.9 | 13.1 | 25.1 | 77.7 | 91.6 | 94.3 | 94.3 |

Fast SCR

| | | | | | | | |
|---|---|---|---|---|---|---|---|
| A.4 | 71.7 | 81.3 | 90.3 | 96.0 | 94.6 | 91.8 | 90.5 |
| C.4 | 71.5 | 79.8 | 89.0 | 95.8 | 95.0 | 92.2 | 90.7 |

NOx conversions after regeneration, %
Standard SCR

| | | | | | | | |
|---|---|---|---|---|---|---|---|
| A.4 | 1.6 | 3.9 | 9.5 | 40.7 | 20.0 | 32.4 | 41.0 |
| C.4 | 1.1 | 2.6 | 6.2 | 41.1 | 59.2 | 71.3 | 70.6 |

Fast SCR

| | | | | | | | |
|---|---|---|---|---|---|---|---|
| A.4 | 55.5 | 65.6 | 77.0 | 93.7 | 93.3 | 84.9 | 81.4 |
| C.4 | 42.7 | 59.8 | 74.4 | 94.8 | 93.5 | 79.9 | 74.9 |

It can be seen that the catalysts comprising Fe-loaded CHA zeolite are also effective for selective catalytic reduction of NOx after aging at high temperature and exhibit acceptable sulfur resistance.

1. A process for preparing a zeolite having a CHA-type framework structure, the framework structure comprising X₂O₃ and YO₂, wherein X is a trivalent element and Y is a tetravalent element, which includes
(1) preparing a synthesis mixture comprising
(A) a source for X₂O₃,
(B) a source for YO₂, and
(C) a source for piperidinium cations represented by formula (I) as organic structure directing agent (OSDA), 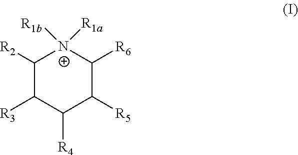
wherein
R₁ₐ is selected from C₁-C₈ alkyl and C₃-C₁₀ cycloalkyl,
R_{1b} is selected from C₂-C₈ alkyl and C₃-C₁₀ cycloalkyl, and
R₂, R₃, R₄, R₅ and R₆ independently from each other, are H, hydroxyl or C₁-C₈ alkyl; and
(2) subjecting the synthesis mixture to crystallization conditions to form a CHA zeolite.

2. The process according to claim 1, wherein the piperidinium cations are represented by the following formula (I), wherein
R₁ₐ is selected from C₁-C₈ alkyl and C₃-C₁₀ cycloalkyl,
R_{1b} is selected from C₃-C₈ alkyl and C₃-C₁₀ cycloalkyl and
R₂, R₃, R₄, R₅ and R₆ independently from each other, are H, hydroxyl or C₁-C₈ alky.

3. The process according to claim 2, wherein the piperidinium cations are represented by formula (Ia) 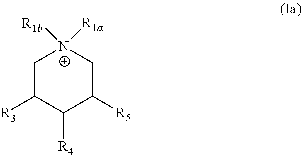
wherein
R₁ₐ is selected from C₁-C₅ alkyl and C₅-C₁₀ cycloalkyl,
R_{1b} is selected from C₃-C₅ alkyl and C₅-C₁₀ cycloalkyl, and
R₃, R₄ and R₅ independently from each other, are H, hydroxyl or C₁-C₅ alkyl.

4. (canceled)

5. (canceled)

6. (canceled)

7. The process according to claim 2, wherein the piperidinium cations are selected from the group consisting of 1-methyl-1-ethylpiperidinium, 1-methyl-1-n-propylpiperidinium, 1-methyl-1-n-butylpiperidinium, 1,1-diethylpiperidinium, 1-ethyl-1-n-propylpiperidinium, 1-ethyl-1-n-butylpiperidinium and any combinations thereof, and preferably from the group consisting of 1-methyl-1-n-propylpiperidinium, 1-methyl-1-n-butylpiperidinium, 1-ethyl-1-n-propylpiperidinium and any combinations thereof.

8. The process according to claim 1, wherein the organic structure directing agent is present in the synthesis mixture in a piperidinium:YO₂ molar ratio relative to source(s) for YO₂, calculated as YO₂, comprised in the in the range of from 0.01 to 1.0, preferably of from 0.03 to 0.5, more preferably of from 0.03 to 0.2, and more preferably of from 0.05 to 0.15.

9. The process according to claim 1, wherein X is selected from the group consisting of Al, B, In, Ga and any combinations thereof, and Y is selected from the group consisting of Si, Sn, Ti, Zr, Ge and any combinations thereof.

10. The process according to claim 9, wherein X is Al and Y is Si.

11. The process according to claim 1, wherein the sources for X₂O₃ and YO₂ comprise FAU zeolites, particularly zeolite Y, more preferably zeolite Y having a molar ratio of XO₂ to Y₂O₃ of no more than 40, preferably of no more than 30, more preferably of no more than 20, and even more preferably of no more than 10.

12. The process according to claim 11, wherein an additional source for YO₂ is used, wherein the additional source for YO₂ is preferably selected from the group consisting of fumed silica, precipitated silica, silica hydrosols, silica gels, and colloidal silica, including mixtures of two or more thereof.

13. The process according to claim 1, wherein the synthesis mixture comprises no organic structure directing agent cations other than the piperidinium cations.

14. A zeolite having a CHA-type framework structure obtained and/or obtainable by the process according to claim 1.

15. A zeolite having a CHA-type framework structure, which, preferably in the as-synthesized form, comprises the piperidinium cations as defined in claim 1 within its pores and/or channels.

16. The zeolite according to claim 14, which has a YO₂:X₂O₃ molar ratio of 2 or more, wherein the YO₂:X₂O₃ molar ratio is preferably comprised in the range of from 4 to 200, more preferably of from 6 to 100, more preferably of from 8 to 50, more preferably of from 10 to 35, more preferably of from 11 to 25, more preferably of from 11.5 to 20, more preferably of from 12 to 16, and more preferably of from 12.5 to 15.

17. The zeolite according to claim 14, wherein the zeolite comprises a promoter metal M, wherein the promoter metal is selected from transition metals, alkali earth metals, Sb, Sn and Bi, and any combinations thereof, preferably comprising Cu and/or Fe, preferably Cu, and wherein the promoter metal is contained within and/or on the surface of the zeolite.

18. (canceled)

19. (canceled)

20. (canceled)

21. The zeolite according to claim 17, wherein the M:X molar ratio of the promoter metal to the trivalent element X in the zeolitic material is comprised in the range of from 0.01 to 2, preferably of from 0.03 to 1.8, more preferably of from 0.05 to 1.5, more preferably of from 0.08 to 1.2, more preferably of from 0.1 to 1.0, more preferably of from 0.13 to 0.8, more preferably of from 0.15 to 0.5, more preferably of from 0.18 to 0.4, more preferably of from 0.2 to 0.38, more preferably of from 0.23 to 35, more preferably of from 0.25 to 32, and more preferably of from 0.28 to 0.3.

22. (canceled)

23. A catalytic article in form of extrudates comprising an SCR catalyst composition or in form of a monolith comprising a washcoat containing an SCR catalyst composition on a substrate, wherein the SCR catalyst composition comprises a zeolite comprising a promoter metal according to claim 17.

24. An exhaust gas treatment system, which comprises an internal combustion engine and an exhaust gas conduit in fluid communication with the internal combustion engine, wherein the catalytic article according to claim 23 is present in the exhaust gas conduit.

25. Use of the zeolite having a CHA-type framework structure according to claim 14 in catalysts for selective catalytic reduction of nitrogen oxides.

26. A method for the selective catalytic reduction of nitrogen oxides, including
(A) providing a gas stream comprising nitrogen oxides (NOx);
(B) contacting the gas stream with a zeolite comprising a promoter metal according to claim 17 or the catalytic article according to claim 16.
